(19) United States
(12) Patent Application Publication
(10) Pub. No.: US 2007/0177261 A1
(43) Pub. Date: Aug. 2, 2007

(54) CATADIOPTRIC TELESCOPES

(76) Inventor: Steven G. Murdock, Mission Viejo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/567,708

(22) Filed: Dec. 6, 2006

Related U.S. Application Data
(60) Provisional application No. 60/748,277, filed on Dec. 7, 2005.

(51) Int. Cl. G02B 23/00

(52) U.S. Cl. 359/399

(57) ABSTRACT

Certain embodiments described herein comprise a telescope comprising primary and secondary mirrors and a corrector. The primary mirror has a first curved reflecting surface having a non-hyperbolic shape. The second secondary mirror has a second curved reflecting surface having a hyperbolic shape. The corrector comprises substantially optically transmissive material. The primary mirror, the secondary mirror, and the corrector are disposed along an optical path such that light propagates through the corrector to the primary mirror and from the primary mirror to the secondary mirror. In certain embodiments, the shapes of the first and second curved reflecting surfaces of the primary and second mirrors, respectively, and the shape and the index of refraction of the optically transmissive material of the corrector are such that the telescope is aplanatic.

### PRIORITY APPLICATIONS

This application claims priority to U.S. Provisional Patent Application No. 60/748,277 entitled “Telescopes Comprising Primary and Secondary Mirrors and Corrector” filed Dec. 7, 2005 (Attorney Docket No. MIC.070PR), which is incorporated herein by reference in its entirety.

### BACKGROUND

1. Field of the Invention

The present teachings relate to catadioptric telescopes and, in particular, telescopes comprising primary and secondary mirrors and a corrector.

2. Description of the Related Art

Many telescopes comprise a primary and secondary mirror without a corrector. Ritchey-Chretien telescopes are an example. The traditional Ritchey-Chretien design comprises a hyperbolic primary and a hyperbolic secondary. Ritchey-Chretien telescopes are available that provide high quality optical imaging. Spherical aberration, coma, and possibly astigmatism are reduced in this telescope design. Ritchey-Chretien telescopes, however, are often relatively expensive compared to other telescope designs, at least in part because of the complexity involved in fabricating the hyperbolic mirrors. What is needed therefore, are designs that are easier to fabricate yet that yield favorable optical performance.

### SUMMARY OF CERTAIN PREFERRED EMBODIMENTS

One embodiment of the invention comprises a telescope comprising a primary mirror, a secondary mirror, and a corrector. The primary mirror has a first curved reflecting surface. The secondary mirror having a second curved reflecting surface, which has a substantially hyperbolic shape. The corrector comprises substantially optically transmissive material. The primary mirror, the secondary mirror, and the corrector are disposed along an optical path such that light propagates through the corrector to the primary mirror and from the primary mirror to the secondary mirror.

Another embodiment of the invention comprises a telescope comprising a non-hyperbolic primary mirror having a substantially non-hyperbolic reflecting surface, a hyperbolic secondary mirror having a substantially hyperbolic reflecting surface, and a corrector comprising substantially optically transmissive material. The non-hyperbolic primary mirror, the hyperbolic secondary mirror, and the corrector are disposed along an optical path such that light propagates through the corrector to the non-hyperbolic primary mirror and from the non-hyperbolic primary mirror to the hyperbolic secondary mirror.

Another embodiment of the invention comprises a method of fabricating a telescope. The method comprises providing a non-hyperbolic primary mirror having a substantially non-hyperbolic reflecting surface, providing a hyperbolic secondary mirror having a substantially hyperbolic reflecting surface, providing a corrector comprising substantially optically transmissive material, and providing a telescope tube having a proximal end and a distal end. The method further comprises disposing the non-hyperbolic primary mirror at the proximal end of the telescope tube and disposing the corrector at the distal end of the telescope tube. The non-hyperbolic primary mirror and the corrector are positioned along an optical path such that light propagates through the corrector to the non-hyperbolic primary mirror and from the non-hyperbolic primary mirror to the hyperbolic secondary mirror.

Another embodiment of the invention comprises a telescope comprising first means for reflecting light, second means for reflecting light, the second reflecting means having hyperbolic shape, and means for refracting light. Light propagates through the refracting means, to the first reflecting means and from the first reflecting means to the second reflecting means.

Another embodiment of the invention comprises a telescope comprising a primary mirror having a first curved reflecting surface, a secondary mirror having a second curved reflecting surface, and a corrector comprising substantially optically transmissive material. The primary mirror, the secondary mirror, and the corrector are disposed along an optical path such that light propagates through the corrector to the primary mirror and from the primary mirror to the secondary mirror. The shapes of the first and second curved reflecting surfaces of the primary and second mirrors, respectively, and the shape and the index of refraction of the optically transmissive material of the corrector are such that the telescope is aplanatic.

Another embodiment of the invention comprises a telescope comprising a primary mirror having a first curved reflecting surface, a secondary mirror having a second curved reflecting surface, and a corrector comprising substantially optically transmissive material and having negligible power. The primary mirror, the secondary mirror, and the corrector are disposed along an optical path such that light propagates through the corrector to the primary mirror and from the primary mirror to the secondary mirror. The shapes of the first and second curved reflecting surfaces of the primary and second mirrors, respectively, and the shape and the index of refraction of the optically transmissive material of the corrector are such that the telescope is aplanatic.

Another embodiment of the invention comprises a telescope comprising a primary mirror having a first curved reflecting surface, a secondary mirror having a second curved reflecting surface, and a corrector having a third curved surface and comprising substantially optically transmissive material. The primary mirror, the secondary mirror, and the corrector are disposed along an optical path such that light propagates through the corrector to the primary mirror and from the primary mirror to the secondary mirror. The second curved reflecting surface of the secondary mirror has substantially the same curvature as and is formed on a portion of the third curved surface of the corrector. The shapes of the first and second curved reflecting surfaces of the primary and second mirrors, respectively, and the shape and the index of refraction of the optically transmissive material of the corrector are such that the telescope is aplanatic.

Another embodiment of the invention comprises a method of fabricating a telescope. This method comprises providing a primary mirror having a first curved reflecting surface, providing a secondary mirror having a second curved reflecting surface, providing a corrector comprising substantially optically transmissive material and having substantially zero power, and providing a telescope tube having a proximal end and a distal end. The method further comprises disposing the primary mirror at the proximal end of the telescope tube and disposing the corrector at the distal end of the telescope tube. The primary mirror and the corrector are positioned along an optical path such that light propagates through the corrector to the primary mirror and from the primary mirror to the secondary mirror. The shapes of the first and second curved reflecting surfaces of the primary and second mirrors, respectively, and the shape and the index of refraction of the optically transmissive material of the corrector are such that the telescope is aplanatic.

Another embodiment of the invention also comprises a method of fabricating a telescope. This method comprises providing a primary mirror having a first curved reflecting surface, providing a secondary mirror having a second curved reflecting surface, providing a corrector having a third curved surface and comprising substantially optically transmissive material, and providing a telescope tube having a proximal end and a distal end. The method further comprises disposing the primary mirror at the proximal end of the telescope tube, and disposing the corrector at the distal end of the telescope tube. The primary mirror and the corrector are positioned along an optical path such that light propagates through the corrector to the primary mirror and from the primary mirror to the secondary mirror. The second curved reflecting surface of the secondary mirror has substantially the same curvature as a portion of the third curved surface of the corrector. The shapes of the first and second curved reflecting surfaces of the primary and second mirrors, respectively, and the shape and the index of refraction of the optically transmissive material of the corrector are such that the telescope is aplanatic.

Another embodiment of the invention comprises a telescope comprising first means for reflecting light, second means for reflecting light, and means for refracting light. The first and second reflecting means and the refracting means are configured such that the telescope is aplanatic.

Another embodiment of the invention comprises a telescope comprising a primary mirror having a first curved reflecting surface, a substantially transmissive optical element, and a secondary mirror. The primary mirror and the substantially transmissive optical element are disposed along an optical path along which light entering the telescope may propagate. The secondary mirror has a second curved reflecting surface and is affixed to the substantially transmissive optical element. The optical path continues onto the secondary mirror from the primary mirror. Light having a plane wavefront incident on the substantially transmissive optical element may propagate along the optical path such that the light has a substantially spherical wavefront after reflection from the primary mirror.

Another embodiment of the invention comprises a telescope comprising a primary mirror having a first curved reflecting surface, a substantially transmissive optical element having substantially zero power, and a secondary mirror having a second curved reflecting surface and affixed to the substantially transmissive optical element. The primary mirror and the substantially transmissive optical element are disposed along an optical path along which light entering the telescope may propagate. The optical path continues onto the secondary mirror from the primary mirror. Light having a plane wavefront incident on the substantially transmissive optical element may propagate along the optical path such that the light has a substantially spherical wavefront after reflection from the primary mirror.

Another embodiment of the invention comprises a telescope comprising a primary mirror having a first curved reflecting surface, a substantially transmissive optical element having a second curved surface, and a secondary mirror having a third curved reflecting surface and affixed to the substantially transmissive optical element. The primary mirror and the substantially transmissive optical element are disposed along an optical path along which light entering the telescope may propagate. The third curved reflecting surface has substantially the same curvature as a portion of the second curved surface. The optical path continuing onto the secondary mirror from the primary mirror. Light having a plane wavefront incident on the substantially transmissive optical element may propagate along the optical path such that the light has a substantially spherical wavefront after reflection from the primary mirror.

Another embodiment of the invention comprises a telescope comprising first means for reflecting light, means for refracting light, and second reflecting means. Light having a plane wavefront incident on the refracting means may propagate such that the light has a substantially spherical wavefront after reflection from the first reflecting means.

Another embodiment of the invention comprises a telescope comprising a primary mirror, a secondary mirror and a Schmidt corrector. The primary mirror has a first curved reflecting surface and the secondary mirror has a second curved reflecting surface. The Schmidt corrector comprises substantially optically transmissive material. The primary mirror, the secondary mirror, and the Schmidt corrector are disposed along an optical path such that light propagates through the Schmidt corrector to the primary mirror and from the primary mirror to the secondary mirror. The shapes of the first and second curved reflecting surfaces of the primary and second mirrors, respectively, and the shape and the index of refraction of the optically transmissive material of the Schmidt corrector are such that the Schmidt telescope is aplanatic. In some embodiments, the first curved reflecting surface is substantially spherically shaped. In some embodiments, the second curved reflecting surface is substantially hyperbolically shaped. In some embodiments the first curved reflecting surface is substantially spherically shaped and the second curved reflecting surface is substantially hyperbolically shaped.

Another embodiment of the invention comprises a telescope comprising a primary mirror, a secondary mirror, and a corrector. The primary mirror has a first curved reflecting surface and the secondary mirror has a second curved reflecting surface. The corrector comprises substantially optically transmissive material. The primary mirror, the secondary mirror, and the corrector are disposed along an optical path such that light propagates through the corrector to the primary mirror and from the primary mirror to the secondary mirror. The shapes of the first and second curved reflecting surfaces of the primary and second mirrors, respectively, and the shape and the index of refraction of the optically transmissive material of the corrector are such that the telescope is aplanatic. The primary and secondary mirrors and the corrector form a Maksutov telescope. In some embodiments, the first curved reflecting surface is substantially spherically shaped. In some embodiments, the second curved reflecting surface is substantially hyperbolically shaped. In some embodiments, the first curved reflecting surface is substantially spherically shaped and the second curved reflecting surface is substantially hyperbolically shaped.

Another embodiment of the invention comprises a method of fabricating a telescope. The method comprises providing a primary mirror having a first curved reflecting surface and providing a secondary mirror having a second curved reflecting surface. The method further comprises providing a Schmidt corrector comprising substantially optically transmissive material and providing a telescope tube having a proximal end and a distal end. The primary mirror is disposed at the proximal end of the telescope tube. The Schmidt corrector and the secondary are disposed at the distal end of the telescope tube. The primary and secondary mirrors and the Schmidt corrector are positioned along an optical path such that light propagates through the corrector to the primary mirror and from the primary mirror to the secondary mirror. The shapes of the first and second curved reflecting surfaces of the primary and second mirrors, respectively, and the shape and the index of refraction of the optically transmissive material of the Schmidt corrector are such that the telescope is aplanatic. In some embodiments, the first reflecting surface comprises a non-hyperbolically shaped surface. In some embodiments, the second reflecting surface comprises a hyperbolically shaped surface. In some embodiments, the corrector has at least one aspheric surface. In some embodiments, the method further comprises providing a shape to the aspheric surface such that a plane wave propagating through the corrector and incident on the primary mirror is transformed into a substantially spherical wavefront upon reflection from the primary mirror.

Another embodiment of the invention comprises a method of fabricating a telescope. This method comprises providing a primary mirror having a first curved reflecting surface and providing a secondary mirror having a second curved reflecting surface. The method further comprises providing a corrector comprising substantially optically transmissive material and providing a telescope tube having a proximal end and a distal end. The primary mirror is disposed at the proximal end of the telescope tube. The corrector and secondary mirror are disposed at the distal end of the telescope tube. The primary mirror, the secondary mirror, and the corrector are positioned along an optical path such that light propagates through the corrector to the primary mirror and from the primary mirror to the secondary mirror. The shapes of the first and second curved reflecting surfaces of the primary and second mirrors, respectively, and the shape and the index of refraction of the optically transmissive material of the corrector are such that the telescope is aplanatic. The primary and secondary mirrors and the corrector form a Maksutov telescope. In some embodiments, the first reflecting surface comprises a non-hyperbolically shaped surface. In some embodiments, the second reflecting surface comprises a hyperbolically shaped surface. In some embodiments, the corrector has at least one aspheric surface. In some embodiments, the method further comprises providing a shape to the aspheric surface such that a plane wave propagating through the corrector and incident on the primary mirror is transformed into a substantially spherical wavefront upon reflection from the primary mirror.

Another embodiment of the invention comprises a telescope comprising means for substantially transmitting light; a first means for reflecting light, and a second means for reflecting light. The first reflecting means is configured to convert collimated wavefronts propagated through the light transmitting means into first converging substantially spherically shaped wavefronts upon reflection. The second reflecting means is configured to reflect the first substantially spherically shaped wavefronts to produce second substantially spherically shaped wavefronts. The telescope comprises a Schmidt telescope or a Maksutov telescope. In some embodiment, the telescope is a Schmidt telescope. In some embodiments, the telescope is a Maksutov telescope. In some embodiments, the first reflecting means has a substantially spherical reflecting surface. In some embodiments, the transmitting means comprises a substantially optically transmissive medium having a substantially aspheric surface. In some embodiments, the transmitting means has negligible power. In some embodiments, the transmitting means and the second reflecting means share a common optical surface. In some embodiments, the optical path is substantially straight. In some embodiments, the light transmitting means comprises a corrector. In some embodiments, the first reflecting means comprises a primary mirror. In some embodiments, the second reflecting means comprises a secondary mirror.

Another embodiment of the invention comprises a telescope comprising a primary mirror having a first curved reflecting surface, a secondary mirror having a second curved reflecting surface, and a corrector comprising substantially optically transmissive material. The primary mirror, the secondary mirror, and the corrector form a Schmidt telescope and are disposed along an optical path such that light propagates through the corrector to the primary mirror and from the primary mirror to the secondary mirror so as to provide a spherically shaped converging wavefront at a focal plane. In some embodiments, the first curved reflecting surface is substantially spherically shaped. In some embodiments, the second curved reflecting surface is substantially hyperbolically shaped. In some embodiments, the first curved reflecting surface is substantially spherically shaped and the second curved reflecting surface is substantially hyperbolically shaped.

Another embodiment of the invention comprises a telescope comprising a primary mirror having a first curved reflecting surface, a secondary mirror having a second curved reflecting surface, and a corrector comprising substantially optically transmissive material. The primary mirror, the secondary mirror, and the corrector form a Maksutov telescope and are disposed along an optical path such that light propagates through the corrector to the primary mirror and from the primary mirror to the secondary mirror so as to provide a spherically shaped converging wavefront at a focal plane. In some embodiments, the first curved reflecting surface is substantially spherically shaped. In some embodiments, the second curved reflecting surface is substantially hyperbolically shaped. In some embodiments, the first curved reflecting surface is substantially spherically shaped and the second curved reflecting surface is substantially hyperbolically shaped.

Another embodiment of the invention comprises a method of fabricating a telescope. The method comprises providing a primary mirror having a first curved reflecting surface, providing a secondary mirror having a second curved reflecting surface, providing a corrector comprising substantially optically transmissive material and having substantially zero power, and providing a telescope tube having a proximal end and a distal end. The method further comprises disposing the primary mirror at the proximal end of the telescope tube and disposing the corrector at the distal end of the telescope tube. The primary mirror and the corrector are positioned along an optical path such that light propagates through the corrector to the primary mirror and from the primary mirror to the secondary mirror. The shapes of the first and second curved reflecting surfaces of the primary and second mirrors, respectively, and the shape and the index of refraction of the optically transmissive material of the corrector are such that the telescope is aplanatic. In some embodiments, the first reflecting surface comprises a non-hyperbolically shaped surface. In some embodiments, The second reflecting surface comprises a hyperbolically shaped surface. In certain embodiments, the corrector has at least one aspheric surface. In certain embodiments, the method further comprising providing a shape to the aspheric surface such that a plane wave propagating through the corrector and incident on the primary mirror is transformed into a substantially spherical wavefront upon reflection from the primary mirror.

Another embodiment of the invention also comprises a method of fabricating a telescope. The method comprises providing a primary mirror having a first curved reflecting surface, providing a secondary mirror having a second curved reflecting surface, providing a corrector having a third curved surface and comprising substantially optically transmissive material, and providing a telescope tube having a proximal end and a distal end. The method further comprises disposing the primary mirror at the proximal end of the telescope tube and disposing the corrector at the distal end of the telescope tube. The primary mirror and the corrector are positioned along an optical path such that light propagates through the corrector to the primary mirror and from the primary mirror to the secondary mirror. The second curved reflecting surface of the secondary mirror has substantially the same curvature as a portion of the third curved surface of the corrector. The shapes of the first and second curved reflecting surfaces of the primary and second mirrors, respectively, and the shape and the index of refraction of the optically transmissive material of the corrector are such that the telescope is aplanatic. In some embodiments, the first reflecting surface comprises a non-hyperbolically shaped surface. In some embodiments, the second reflecting surface comprises a hyperbolically shaped surface. In certain embodiments, the corrector has at least one aspheric surface. In various embodiments, the method further comprises providing a shape to the aspheric surface such that a plane wave propagating through the corrector and incident on the primary mirror is transformed into a substantially spherical wavefront upon reflection from the primary mirror.

Another embodiment of the invention also comprises a method of fabricating a telescope. The method comprises providing a non-hyperbolic primary mirror having a substantially non-hyperbolic reflecting surface, providing a hyperbolic secondary mirror having a substantially hyperbolic reflecting surface, providing a corrector comprising substantially optically transmissive material, and providing a telescope tube having a proximal end and a distal end. The method further comprises disposing the non-hyperbolic primary mirror at the proximal end of the telescope tube and disposing the corrector at the distal end of the telescope tube. The non-hyperbolic primary mirror and the corrector are positioned along an optical path such that light propagates through the corrector to the non-hyperbolic primary mirror and from the non-hyperbolic primary mirror to the hyperbolic secondary mirror. In some embodiments, the telescope is a Schmidt telescope. In some embodiments, the corrector has negligible optical power. In certain embodiments, the telescope is a Maksutov telescope. In certain embodiments, the secondary mirror and the corrector share a common curved optical surface. In various embodiment the method further comprises providing a substantially spherical reflecting surface on the non-hyperbolic primary mirror. In some embodiments, the method further comprises providing at least one substantially aspheric surface on the corrector. In some embodiments, the method further comprises providing a shape to the aspheric surface such that collimated light comprising planar wavefronts that propagates through the corrector and is incident on the non-hyperbolic primary mirror comprises substantially spherical wavefronts upon reflection from the non-hyperbolic primary mirror. In certain embodiments, the sum of the spherical aberration, coma, and astigmatism of the telescope is not more than about ±0.25 waves.

### BRIEF DESCRIPTION OF THE DRAWINGS

Example embodiments of the telescopes and method of fabricating telescopes disclosed herein are illustrated in the accompanying drawings, which are for illustrative purposes only.

FIG. 1 is a schematic cross-sectional view of one embodiment of a telescope comprising a spherical primary mirror, a hyperbolic secondary mirror, and a corrector plate, wherein the secondary mirror is affixed to the corrector plate;

FIG. 2 is a schematic cross-sectional view of another embodiment of a telescope comprising a spherical primary mirror, a hyperbolic secondary mirror, and a corrector lens, wherein the secondary mirror comprises a reflecting surface formed on the corrector lens;

FIG. 3 is a perspective view of the exterior of a telescope showing a telescope tube that houses primary and secondary mirrors and a corrector.

### DETAILED DESCRIPTION OF CERTAIN PREFERRED EMBODIMENTS

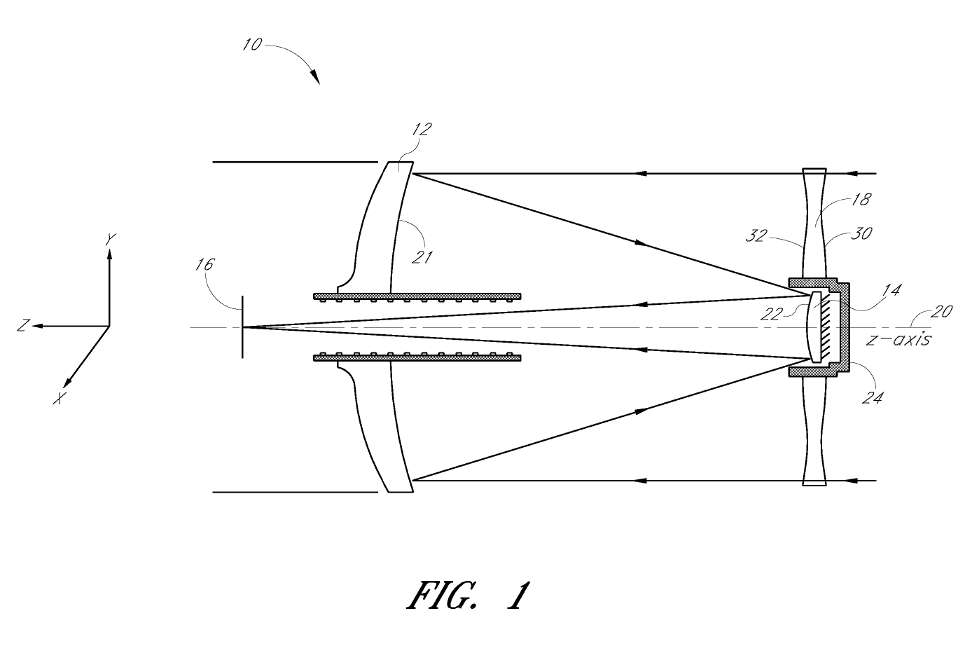

FIG. 1 depicts a telescope 10 comprising a primary mirror 12 and a secondary mirror 14. The telescope 10 further comprises a refracting corrector plate 18. The primary mirror 12, secondary mirror 14, and corrector plate 18 are aligned about an optical axis 20 centrally located through the telescope 10. This optical axis 20 is designated as the z-axis in FIG. 1 and has orthogonal x- and y-axes. The telescope further includes a focal plane 16 as shown.

The primary mirror 12 may have, for example, a concave reflecting surface 21. The primary mirror 12 may comprise glass or Pyrex that is polished or shaped to form the curved reflecting surface 21. The surface 21 may be coated to provide a strong reflectivity. In some embodiments, the reflective coating may comprise metallization.

The secondary mirror 14 also has a curved reflecting surface 22. In various embodiments, the curved reflecting surface 22 on the secondary mirror 14 is a convex surface. Like the primary mirror 12, the secondary mirror 14 may also comprise glass or pyrex and may be shape, polished and coated to form the curved reflecting surface 22. In some embodiments, the reflective coating may comprise metallization. Other materials can be used for the primary and secondary mirrors 12, 14. Techniques for designing optical elements such as the primary mirrors and secondary mirrors described herein are known to those skilled in the art who may use, for example, ray tracing software and optimization algorithms in different embodiments. Techniques for fabricating optical elements such as the primary mirrors and secondary mirrors described herein are also known to those skilled in the art who may use spindles, slurries, deposition and coating systems, and possibly automated machines in different embodiments.

The concave reflecting surface 21 of the primary mirror 12 has a shape that is substantially nonhyperbolic. In various preferred embodiments of the invention, the primary mirror 12 is a spherical mirror and the secondary mirror 14 is a hyperbolic mirror. In particular, the curved reflecting surface 21 on the primary mirror 12 comprises a spherical surface. Such a spherical surface has the shape of a spheroid. In some embodiments, the primary mirror 12 deviates from a sphere on average by no more than ±½ wave, no more than ±¼ wave, or no more than ±⅛ wave. Likewise, the curved reflecting surface 22 on the secondary mirror 14 comprises a hyperbolic surface. Such a hyperbolic surface has the shape of a hyperboloid. As is well known, a surface having the shape of a spheroid may be generated by rotating a circle or circular arc about an axis through the center of curvature of the arc or circle. As is also well known, a surface having the shape of a hyperboloid may be generated by rotating a hyperbola about an axis through the foci of the hyperbola. In some embodiments, the secondary mirror 14 deviates from a hyperboloid on average by no more than ±1 wave, no more than ±½ wave, or no more than ±¼ wave. Forming a spherical primary may be easier than forming a hyperbolic primary.

For example, the primary mirror 12 is more spherical than hyperbolic, or parabolic, or elliptical. The secondary mirror 14 is more hyperbolic than spherical, or parabolic, or elliptical. Other shapes, however, are possible.

The refractive corrector plate 18 is a transparent optical element comprising for example glass or other materials substantially transmissive to light such as infrared, visible, or ultraviolet light. The corrector plate 18 has forward and rearward surfaces 30 and 32. The forward surface 30 is directed toward the object and the rearward surface 32 faces the primary mirror 12. The front and rear surface 30, 32 of the corrector 18 may be rotationally symmetric (e.g., about the optical axis). In various preferred embodiments, at least one of the surfaces 30 or 32, and possibly both, has a shape that is aspheric. The corrector may also include an anti-reflection (AR) coating in certain embodiments. Techniques for designing optical elements such as the corrector described herein are known to those skilled in the art who may use, for example, ray tracing software and optimization algorithms in different embodiments. Similarly, techniques for fabricating optical elements such as the corrector described herein are also known to those skilled in the art who may use spindles, slurries, deposition and coating systems, and possibly automated machines in different embodiments.

Although the corrector plate is shown as having front and rear curved surfaces 30, 32, one of the front or rear surfaces may be substantially flat in certain embodiments. In certain preferred embodiments, the corrector plate 18 has negligible optical power and is referred to as a Schmidt corrector. This Schmidt corrector plate, although containing no power, provides optical correction. As is well know, a Schmidt (e.g. Schmidt Cassegrain) telescope comprises a primary mirror, a secondary mirror, and a corrector plating referred to as a Schmidt corrector, having zero optical power but that introduces optical correction. The telescope 10 illustrated in FIG. 1, having both reflective and refractive optical elements, is also referred to as a catadioptric telescope.

In various embodiments, the secondary mirror 14 is rigidly affixed to the corrector plate 18 such that the two optical elements are connected together. FIG. 1 depicts a baffle 24 between the corrector plate 18 and the secondary mirror 14. The corrector 18 may, however, be attached to the secondary mirror 14 through the baffle 24 or other structure that secures the corrector plate 18 and the secondary mirror 14 together.

As shown in FIG. 1, collimated rays from, for example, an object (e.g., a celestial or terrestrial object), are received by the telescope 10. The light propagates to the primary mirror 12. As described above, the shape of the curved reflecting surface 21 of the primary mirror 12 is spherical or substantially spherical. The curved concave reflecting surface 21 redirects the beam toward the secondary mirror 14. The beam approaching the secondary mirror 14 comprises converging wavefronts. The converging beam reflects off the convex curved reflecting surface 22 of the secondary mirror 14. In various embodiments of the invention, the convex curved reflecting surface 22 of the secondary mirror 14 is hyperbolic or substantially hyperbolic also as described above. The beam continues to converge toward the focal plane 16 where the beam is focused.

In various embodiments described herein, the shape of at least one of the surfaces 30, 32 of the corrector plate 18 is aspheric. In certain preferred embodiments, the shape of at least one of the surfaces 30, 32 is such that a beam having a plane wavefront propagating through the corrector plate 18 is transformed upon reflection from the substantially spherical surface 21 of the primary mirror 12 into a substantially spherically shaped wavefront. In some embodiments, the wavefront deviates from a sphere on average by no more than ±1 wave, no more than ±½ wave, or no more than ±¼ wave. The substantially spherical wavefront propagates to the secondary mirror 14 and reflects off the substantially hyperbolic reflecting surface 22 of the secondary. The wavefront reflected from the secondary is also substantially spherical in certain preferred embodiments. Accordingly, the shapes of the corrector 18, primary 12, and secondary 14, are such that the beam having a planar wavefront received by the telescope 10 is transformed upon reflection from the substantially hyperbolic surface 22 of the secondary mirror into a substantially spherically shaped wavefront. This beam converges toward the focal plane 16 where the beam is focused.

An image of the object is formed at this focal plane 16. Accordingly, an optoelectronic imaging device such as a CMOS or CCD camera can be disposed at, near, or with respect to the focal plane 16 to record an image of the object. Alternatively, an ocular can be positioned relative to the focal plane 16 to permit viewing of the image with the eye. In other configurations, optics or optical instruments, such as for example a spectrometer, can be suitably located with respect to the focal plane 16 to receive the light from the distant object. In some embodiments, additional optics may be included such as one or more mirrors for turning the beam of light, an ocular lens or lenses, a camera lens or lenses, a spectrometer grating, etc.

In various preferred embodiments of the present invention, the secondary mirror 14 can be moved to focus and collimate the telescope 10. The secondary 14 can be translated longitudinally along the longitudinal (z-axis), toward or away from the primary 12 to focus. The secondary 14 can also be tilted in different directions to collimate. For example, the secondary 14 may be tilted about the orthogonal x- or y-axes or other axes orthogonal to optical axis 20. See U.S. patent application Ser. No. 10/899,221 entitled “APPARATUS AND METHODS FOR FOCUSING AND COLLIMATING TELESCOPES”, filed Jul. 26, 2004, published as U.S. 2006/0018012 A1, which is incorporated herein by reference in its entirety.

In certain preferred configurations where the secondary mirror 14 is affixed to the corrector 18, the corrector 18 may be translated or tilted to effectuate the desired longitudinal displacement or tilt of the secondary mirror 14. One or more actuators, for example, may be affixed to the corrector 18 to execute such movements. In various preferred embodiments, these actuators are at the perimeter of the corrector 18 and manipulate the corrector from its perimeter.

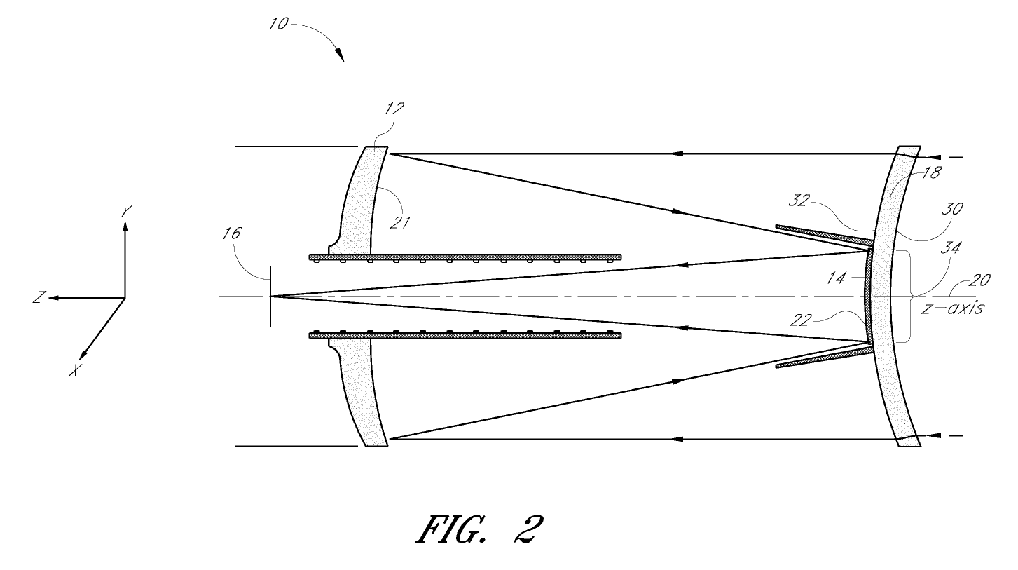

Another embodiment of a telescope is shown in FIG. 2. This catadioptric telescope 10 comprises a Maksutov telescope wherein the secondary mirror 14 forms part of the corrector lens 18. In the embodiment shown in FIG. 2, the corrector lens 18 comprises a refractive optical element having forward and rearward surfaces 30, 32. The forward surface 30 is directed toward the object and the rearward surface 32 faces the primary 12. The corrector lens 18 depicted in FIG. 2 is substantially optically transparent with the exception of a central region 34 thereof. This corrector 18, for example, may be transparent to infrared, visible, or ultraviolet light in some embodiments. The forward and rearward surface 30, 32 of the corrector lens 18 are substantially optically transmissive surfaces to light propagating from an object (e.g., a celestial or terrestrial object) through the corrector 18 and to the primary mirror 12. Preferably, at least one, and possibly both, of the surfaces 30, 32 is curved, and one or both of the surfaces 30, 32 may be aspheric. In various embodiments, one or both of the surfaces 30, 32 are rotationally symmetric about the optical axis (e.g., z-axis). The refractive optical element 18 shown comprises a meniscus lens. In various preferred embodiments, the central portion 34 of the rearward surface 32 is coated to form a substantially reflective surface corresponding to the secondary mirror 14. The reflective coating may comprise, for example, metallization. Other reflective coatings may also be employed as well. As a result of the shape of the corrector 18, the shape of the surface 22 of the secondary mirror 14 is convex. In certain embodiments, the shape of the secondary mirror surface 22 is hyperbolic or substantially hyperbolic. Accordingly, in some embodiments, the shape of the rearward surface 32 of the corrector 18 is hyperbolic or substantially hyperbolic to cause the shape of the surface 22 of the secondary 14 to be substantially hyperbolic. In some embodiments, the secondary mirror 14 deviates from a hyperboloid on average by no more than ±1 wave, no more than ±½ wave, or no more than ¼ wave.

As described above, in various preferred embodiments of the telescope illustrated in FIG. 2, the central portion 34 of the forward surface 30 may be configured to form the secondary mirror 14, such as, for example, by coating the central portion 34 of the rearward surface 32 to form a substantially reflective surface. Accordingly, when the telescope is directed at a distant object such as a star, planet, or other celestial or terrestrial object, a collimated beam of light rays from the object is received by the telescope 10 and passes through the corrector lens 18. The light propagates to the primary mirror 12 where the curved concave reflecting surface 21 redirects the beam toward the secondary mirror 14. The beam propagates to the corrector lens 18 and reflects off the convex curved reflecting surface 22 of the secondary mirror 14 formed on the rearward surface 32 of the corrector. The beam propagates from the secondary mirror 14 toward the focal plane 16. The beam continues to converge toward the focal plane 16 where the beam is focused.

In other preferred embodiments, the central portion 34 of the forward surface 30 may be configured to form the secondary mirror 14, such as, for example, by coating the central portion 34 of the forward surface 30 to form a substantially reflective surface. A collimated beam of light rays from, for example, an object is received by the telescope 10 and passes through the corrector lens 18. The light propagates to the primary mirror 12 where the curved concave reflecting surface 21 redirects the beam toward the secondary mirror 14. The beam propagates into the corrector lens 18 and reflects off the convex curved reflecting surface 22 of the secondary mirror 14 formed on the forward surface 30 of the corrector. The beam propagates out of the corrector lens 18 toward the focal plane 16. Accordingly, in these preferred embodiments, the beam passes through the corrector lens 18 three times rather than one time as in the case where the secondary mirror 14 is formed on the rearward surface 32. The beam continues to converge toward the focal plane 16 where the beam is focused.

In certain embodiments, the primary 12 is spherical or substantially spherical. As described above, in some embodiments, the primary mirror 12 deviates from a sphere on average by no more than ±½ wave, no more than ±¼ wave, or no more than ±⅛ wave. Additional, the primary mirror 12 is more spherical than hyperbolic, or parabolic, or elliptical. The secondary mirror 14 is more hyperbolic than spherical, or parabolic, or elliptical. Other shapes, however, are possible.

As described above, techniques for designing optical elements such as the primary, secondary, and corrector described herein are known to those skilled in the art who may use, for example, ray tracing software and optimization algorithms in different embodiments. Similarly, techniques for fabricating optical elements such as the primary, secondary, and corrector described herein are also known to those skilled in the art who may use spindles, slurries, deposition and coating systems, and possibly automated machines in different embodiments.

In certain preferred embodiments, the shape of at least one of the surfaces 30, 32 is such that a beam having a plane wavefront propagating through the corrector plate 18 is transformed upon reflection from the substantially spherical surface 21 of the primary mirror 12 into a substantially spherically shaped wavefront. In some embodiments, the wavefront deviates from a sphere on average by no more than ±½ waves, no more than ±¼ waves, or no more than ±⅛ wave.

Accordingly, in various preferred embodiments of the telescope 10 the shape of the surface 21 of the primary mirror 12 is substantially spherical and the shape of the secondary is substantially hyperbolic. Moreover, the shapes of one or both of the surfaces 30, 32 of the corrector 18 may be such that an incident plane wavefront propagating through the corrector 18 is transformed upon reflection from the surface 21 of the primary mirror 12 into a substantially spherical wavefront. For example, in some embodiments, the wavefront reflected from the primary 12 deviates from a sphere on average by no more than ±½ wave, no more than ±¼ waves, or no more than ±⅛ wave. Similarly, the wavefront reflected from the secondary is also substantially spherical in certain embodiments. Accordingly, in various preferred embodiments, the telescope 10 is aplanatic as discussed more fully below.

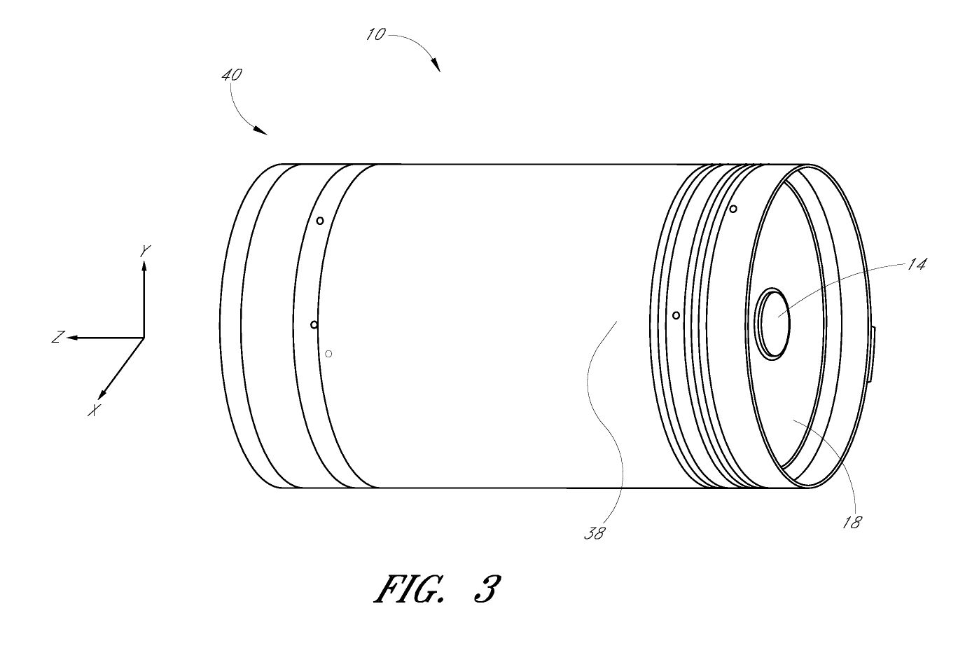

A closed-tube design shown in FIG. 3 keeps the optical elements substantially free from dust, moisture, and contaminates. As illustrated in FIG. 3, an embodiment of the telescope 10 comprises a tube 38 that forms part of a tube assembly 40 for housing the primary mirror 12, the secondary mirror 14, and the corrector 18. The tube 38 has a front end and a rear end. The front end of the tube 38 may be directed toward a distant object to be viewed. The distant object may be, for example, a terrestrial or a celestial object.

The corrector 18 is disposed at the front end of the tube 38. In some embodiments, the corrector 18 may comprise a Schmidt corrector having negligible power. In other embodiments, the corrector 18 may comprise an embodiment of a Maksutov (e.g. a Maksutov Cassegrain) corrector wherein the secondary mirror 14 forms part of the corrector 18. The corrector may, for example, comprises a meniscus lens. The primary mirror 12 is disposed at the rear end of the tube 38. In various embodiments, the secondary mirror 14 is preferably located at the center of the corrector plate 18. The primary and secondary mirrors 12 and 14 and the corrector plate 18 may also be centered about a central axis of the tube 18. In certain embodiments, the central axis (e.g., z-axis) of the tube 18 substantially coincides with the optical axis 20 of the telescope 10.

The telescope tube 38 may be fabricated from materials that are light-weight, have high strength, and have ultra-low thermal expansion characteristics that will maintain the spacing between the optics, so that focus settings do not change with outside temperature changes. Suitable materials include, for example, carbon fiber or a carbon, graphite, and Kevlar™ composition. The embodiment shown in FIG. 3 is a closed-tube design, which keeps the optical components free from dust, moisture and other contaminates.

Other variations in the telescope 10 are possible. For example, the primary 12 may deviate from spherical. Moreover, in some embodiments, the primary 12 may be aspheric. The combination of the corrector 18 and the primary 12 may, however, produce a substantially spherically shaped wavefront in certain embodiments. Similarly, the secondary 14 may deviate from hyperbolic. The primary 12, secondary 14, and corrector 18, may however, produce a spherical wavefront at the focal plane 16. Additionally, the corrector need not have negligible power. Similarly, the corrector need not be meniscus. Other variations in the optical design are also possible.

Accordingly, various preferred embodiments of the telescope 10 comprise an aplanatic optical system. As is well known, an aplanatic optical system is corrected for spherical aberration and coma. In some embodiments, for example, the spherical aberration and coma together total no more than ±¼ wave, no more than ⅛ wave, or no more than 1/16 wave of aberration. In some embodiments, the spherical aberration, coma, and astigmatism together total no more than ±¼ wave, no more than ⅛ wave, or no more than 1/16 wave of aberration. With no spherical aberration or coma present, the wavefront converges as a spherical wavefront. In some embodiments, the diffraction limit is obtained for some wavelengths. Thus, although the shapes of the primary and secondary can deviate from spherical and hyperbolic in various preferred embodiments, the resultant optical system may be aplanatic in certain preferred designs. The shape of the corrector 18 may also be designed to produce such an aplanatic system.

An aplanatic telescope offers the advantage of improved imaging. Correction of spherical aberration and coma provides clear high resolution imaging.

The telescope design disclosed herein having a refracting corrector 18, a substantially spherical primary 12, and a substantially hyperbolic secondary 14 also offers various advantages including improved imaging. For example, in contrast with a traditional Ritchey-Chretien design, which comprises a hyperbolic primary and a hyperbolic secondary but that does not incorporate a corrector, spherical aberration, coma, and possibly astigmatism are reduced in this telescope 10. Additionally, the spherical primary mirror 12 is easier to fabricate than a hyperbolic primary in a Ritchey-Chretien telescope.

Variations in the design in addition to the shape of the primary 12, secondary 14, and corrector 18 are also possible. Components may be added or removed from the telescope materials or may be altered. Different materials, dimensions, and/or configurations may be used. The arrangement of components may vary as well.

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in other contexts.

What is claimed is:

1. A telescope comprising:
a primary mirror having a first curved reflecting surface;
a secondary mirror having a second curved reflecting surface having a substantially hyperbolic shape; and
a corrector comprising substantially optically transmissive material,
wherein said primary mirror, said secondary mirror, and said corrector are disposed along an optical path such that light propagates through said corrector to said primary mirror and from said primary mirror to said secondary mirror.

2. The telescope of claim 1, wherein the telescope is a Schmidt telescope.

3. The telescope of claim 1, wherein said first curved reflecting surface is substantially non-hyperbolically shaped.

4. The telescope of claim 2, wherein said first curved reflecting surface is substantially spherically shaped.

5. The telescope of claim 4, wherein said first curved reflecting surface deviates from a sphere on average by no more than about ±¼ wave and said second curved reflecting deviates surface from hyperbolic on average by no more than about ±½ wave.

6. The telescope of claim 1, wherein the corrector has substantially zero power.

7. The telescope of claim 1, wherein the telescope is a Maksutov telescope.

8. The telescope of claim 1, wherein the secondary mirror comprises a curved reflecting surface formed on a surface of the optically transmissive material of the corrector.

9. A telescope comprising:
a non-hyperbolic primary mirror having a substantially non-hyperbolic reflecting surface;
a hyperbolic secondary mirror having a substantially hyperbolic reflecting surface;
a corrector comprising substantially optically transmissive material,
wherein said non-hyperbolic primary mirror, said hyperbolic secondary mirror, and said corrector are disposed along an optical path such that light propagates through said corrector to said non-hyperbolic primary mirror and from said non-hyperbolic primary mirror to said hyperbolic secondary mirror.

10. The telescope of claim 9, wherein said telescope is a Schmidt telescope.

11. The telescope of claim 9, wherein said corrector has substantially zero power.

12. The telescope of claim 9, wherein said telescope is a Maksutov telescope.

13. The telescope of claim 9, wherein said secondary mirror comprises a reflective surface formed on an optical surface of said corrector.

14. The telescope of claim 9, wherein the non-hyperbolic primary mirror has a substantially spherical reflecting surface.

15. The telescope of claim 14, wherein said substantially spherical reflecting surface deviates from a sphere on average by no more than about ±¼ wave.

16. The telescope of claim 9, wherein said corrector comprises an aspheric corrector having at least one substantially aspheric surface.

17. The telescope of claim 16, wherein the substantially aspheric surface has a shape such that a plane wave propagating through the corrector and incident on the non-hyperbolic primary mirror is transformed into a substantially spherical wavefront upon reflection from the non-hyperbolic primary mirror.

18. The telescope of claim 9, further comprising a telescope tube that houses said corrector and said primary and secondary mirrors.

19. The telescope of claim 18, wherein the corrector and primary and secondary mirrors are centered about a central axis through the telescope tube.

20. The telescope of claim 19, wherein said central axis through the telescope tube substantially coincides with said optical path.

21. The telescope of claim 9, wherein said substantially hyperbolic reflecting surface deviates from a hyperboloid on average by no more than about ±½ wave.

22. A telescope comprising:
first means for reflecting light;
second means for reflecting light, said second reflecting means having hyperbolic shape; and
means for refracting light,
wherein light propagates through the refracting means, to the first reflecting means and from the first reflecting means to the second reflecting means.

23. The telescope of claim 22, wherein said first reflecting means comprises a primary mirror, said second reflecting means comprises a secondary mirror, and said refracting means comprises a corrector.

24. A telescope comprising:
a primary mirror having a first curved reflecting surface;
a secondary mirror having a second curved reflecting surface; and
a corrector comprising substantially optically transmissive material, said primary mirror, said secondary mirror, and said corrector being disposed along an optical path such that light propagates through said corrector to said primary mirror and from said primary mirror to said secondary mirror,
wherein the shapes of the first and second curved reflecting surfaces of said primary and second mirrors, respectively, and the shape and the index of refraction of said optically transmissive material of said corrector are such that said telescope is aplanatic.

25. The telescope of claim 24, wherein said first curved reflecting surface is substantially non-hyperbolically shaped.

26. The telescope of claim 25, wherein said first curved reflecting surface is substantially spherically shaped.

27. The telescope of claim 26, wherein said first curved reflecting surface deviates from a sphere on average by no more than about ±¼ wave.

28. The telescope of claim 24, wherein said second curved reflecting surface is substantially hyperbolically shaped.

29. The telescope of claim 28, wherein said second curved reflecting surface deviates from hyperbolic on average by no more than about ±½ waves.

30. A telescope comprising:
a primary mirror having a first curved reflecting surface;
a secondary mirror having a second curved reflecting surface; and
a corrector comprising substantially optically transmissive material and having negligible power, said primary mirror, said secondary mirror, and said corrector being disposed along an optical path such that light propagates through said corrector to said primary mirror and from said primary mirror to said secondary mirror,
wherein the shapes of the first and second curved reflecting surfaces of said primary and second mirrors, respectively, and the shape and the index of refraction of said optically transmissive material of said corrector are such that said telescope is aplanatic.

31. The telescope of claim 30, wherein said first curved reflecting surface has a non-hyperbolic shape.

32. The telescope of claim 31, wherein said first curved reflecting surface is substantially spherically shaped.

33. The telescope of claim 32, wherein said first curved reflecting surface deviates from a sphere on average by no more than about ±¼ wave.

34. The telescope of claim 30, wherein said second curved reflecting surface is substantially hyperbolically shaped.

35. The telescope of claim 34, wherein said second curved reflecting surface deviates from a hyperboloid on average by no more than about ±½ wave.

36. The telescope of claim 30, wherein the sum of the spherical aberration, coma, and astigmatism is not more than about ±0.25 waves.

37. A telescope comprising:
a primary mirror having a first curved reflecting surface;
a secondary mirror having a second curved reflecting surface; and
a corrector having a third curved surface and comprising substantially optically transmissive material, said primary mirror, said secondary mirror, and said corrector being disposed along an optical path such that light propagates through said corrector to said primary mirror and from said primary mirror to said secondary mirror,
wherein said second curved reflecting surface of said secondary mirror has substantially the same curvature as and is formed on a portion of said third curved surface of said corrector, and,
wherein the shapes of the first and second curved reflecting surfaces of said primary and second mirrors, respectively, and the shape and the index of refraction of said optically transmissive material of said corrector are such that said telescope is aplanatic.

38. The telescope of claim 37, wherein said first curved reflecting surface is substantially spherically shaped.

39. The telescope of claim 38, wherein said first curved reflecting surface deviates from a sphere on average by no more than about ±¼ wave.

40. The telescope of claim 37, wherein said second curved reflecting surface is substantially hyperbolically shaped.

41. The telescope of claim 40, wherein said second curved reflecting surface deviates from a hyperboloid on average by no more than about ±½ wave.

42. The telescope of claim 37, wherein the sum of the spherical aberration, coma, and astigmatism is not more than about ±0.25 waves.

43. A telescope comprising:
first means for reflecting light;
second means for reflecting light; and
means for refracting light,
wherein the first and second reflecting means and the refracting means are configured such that said telescope is aplanatic.

44. The telescope of claim 43, wherein said first reflecting means comprises a primary mirror, said second reflecting means comprises a secondary mirror, and said refracting means comprises a corrector.

45. A telescope comprising:
a primary mirror having a first curved reflecting surface;
a substantially transmissive optical element, said primary mirror and said substantially transmissive optical element disposed along an optical path along which light entering the telescope may propagate; and
a secondary mirror having a second curved reflecting surface and affixed to said substantially transmissive optical element, said optical path continuing onto said secondary mirror from said primary mirror,
wherein light having a plane wavefront incident on said substantially transmissive optical element may propagate along said optical path such that said light has a substantially spherical wavefront after reflection from said primary mirror.

46. A telescope comprising:
a primary mirror having a first curved reflecting surface;
a substantially transmissive optical element having substantially zero power, said primary mirror and said substantially transmissive optical element disposed along an optical path along which light entering the telescope may propagate; and
a secondary mirror having a second curved reflecting surface and affixed to said substantially transmissive optical element, said optical path continuing onto said secondary mirror from said primary mirror,
wherein light having a plane wavefront incident on said substantially transmissive optical element may propagate along said optical path such that said light has a substantially spherical wavefront after reflection from said primary mirror.

47. The telescope of claim 46, wherein said second curved reflecting surface is substantially hyperbolic.

48. The telescope of claim 46, wherein said light has a substantially spherical wavefront after reflection from said secondary mirror.

49. The telescope of claim 46, wherein said first curved reflecting surface is substantially spherical and said second curved reflecting surface is substantially hyperbolic, and said first curved reflecting surface deviates from a sphere on average by no more than about ±¼ wave and said second curved reflecting surface deviates from hyperbolic on average by no more than about ±½ wave.

50. The telescope of claim 46, wherein said wavefront deviates from a sphere on average by no more than about ±½ waves.

51. A telescope comprising:
a primary mirror having a first curved reflecting surface;
a substantially transmissive optical element having a second curved surface, said primary mirror and said substantially transmissive optical element disposed along an optical path along which light entering the telescope may propagate; and
a secondary mirror having a third curved reflecting surface and affixed to said substantially transmissive optical element, said third curved reflecting surface having substantially the same curvature as a portion of said second curved surface, and said optical path continuing onto said secondary mirror from said primary mirror,
wherein light having a plane wavefront incident on said substantially transmissive optical element may propagate along said optical path such that said light has a substantially spherical wavefront after reflection from said primary mirror.

52. The telescope of claim 51, wherein said second curved reflecting surface is substantially hyperbolic.

53. The telescope of claim 51, wherein said light has a substantially spherical wavefront after reflection from said secondary mirror.

54. The telescope of claim 51, wherein said first curved reflecting surface is substantially spherical and said second curved reflecting surface is substantially hyperbolic, and said first curved reflecting surface deviates from a sphere on average by no more than about ±¼ wave and said second curved reflecting surface deviates from hyperbolic on average by no more than about ±½ wave.

55. The telescope of claim 51, wherein said wavefront deviates from a sphere on average by no more than about ±½ wave.

56. A telescope comprising:
first means for reflecting light;
means for refracting light; and
second reflecting means,
wherein light having a plane wavefront incident on said refracting means may propagate such that said light has a substantially spherical wavefront after reflection from said first reflecting means.

57. The telescope of claim 56, wherein said first reflecting means comprises a primary mirror, said second reflecting means comprises a secondary mirror, and said refracting means comprises a corrector.
